(19) United States
(12) Patent Application Publication
(10) Pub. No.: US 2019/0326790 A1
(43) Pub. Date: Oct. 24, 2019

(54) BRUSHLESS STARTER ROTOR ASSEMBLY

(71) Applicant: GM Global Technology Operations LLC, Detroit, MI (US)

(72) Inventors: Lei Hao, Troy, MI (US); Chandra S. Namuduri, Troy, MI (US); Alexandru Rajala, Farmington Hills, MI (US); Thomas W. Nehl, Shelby Township, MI (US); Suresh Gopalakrishnan, Troy, MI (US); Avoki M. Omekanda, Rochester, MI (US)

(73) Assignee: GM Global Technology Operations LLC, Detroit, MI (US)

(21) Appl. No.: 15/961,176

(22) Filed: Apr. 24, 2018

(51) Int. Cl. H02K 1/30; F02N 11/08; F16H 1/28; H02K 5/15; H02K 7/08; H02K 7/116; H02K 11/21; H02K 15/16

(52) U.S. Cl. CPC H02K 1/30; F02N 11/08; F16H 1/28; H02K 15/165; H02K 7/083; H02K 7/116; H02K 11/21; H02K 5/15

(57) ABSTRACT

A brushless electric motor includes a motor casing having a first bearing, a motor end-cap including a second bearing, a multi-phase stator assembly, and a rotor assembly having a rotor shaft. The shaft has a first end, a second end, and a knurled section therebetween. The shaft also has a first bearing surface proximate the first end and supported by the first bearing, a second bearing surface proximate the second end and supported by the second bearing, and a rotor position and speed sensor target. The shaft additionally has a sun gear integrated with the shaft proximate the first bearing surface for engaging a partial planetary gear set. The rotor assembly also includes a rotor lamination fixed to the shaft at the knurled section and having opposing first and second sides, and first and second end plates arranged on the respective first and second sides of the rotor lamination.

### INTRODUCTION

The present disclosure relates to a rotor assembly for a brushless electric motor used in an electric starter for an internal combustion engine.

A typical internal combustion engine frequently uses an electric starter to turn the engine's crankshaft leading up to a start event to initiate a combustion start of the engine. A typical starter includes a pinion gear that is driven by an electric motor, and that is pushed out for engagement with a ring gear that is attached to the engine's crankshaft flywheel or flex-plate, in order to start the engine.

In some vehicle applications, a stop-start system is employed, where the engine is automatically stopped or shut off to conserve fuel when vehicle propulsion is not required, and is then automatically re-started by such a starter when drive torque is again requested. Such a stop-start system may be employed in a vehicle having a single powerplant, or in a hybrid vehicle application that includes both an internal combustion engine and a motor/generator for powering the vehicle.

The electric starter can be an electric motor having contact brushes to conduct current between stationary wires on a stator portion and moving parts of a rotor portion. The physical contacts may wear over time. Additionally, a brushed motor delivers substantially zero torque near the upper bound of its available speed range.

### SUMMARY

A brushless electric motor includes a motor casing having a first bearing and a motor end-cap including a second bearing. The electric motor also includes a multi-phase stator assembly arranged inside the motor casing concentrically with respect to a first axis, and a rotor assembly arranged for rotation inside the stator assembly. The rotor assembly includes a rotor shaft arranged on the first axis. The rotor shaft has a first end, a second end, and a knurled section arranged between the first end and the second end. The rotor shaft also has a first bearing surface arranged proximate the first end and supported by the first bearing, a second bearing surface arranged proximate the second end and supported by the second bearing, and a rotor position and speed sensor target. The rotor shaft additionally has a sun gear integrated with the rotor shaft proximate the first bearing surface and configured to engage a partial planetary gear set. The rotor assembly also includes a rotor lamination having a first side and an opposing second side, wherein the rotor lamination is fixed to the rotor shaft at and by the knurled section for rotation therewith about the first axis. The rotor assembly additionally includes a first end plate arranged on the first side of the rotor lamination and a second end plate arranged on the second side of the rotor lamination.

The rotor shaft may additionally include a non-magnetic support element proximate the second end. The support element may be a separate component fixed to the rotor shaft.

The non-magnetic support element may be configured to support and retain the rotor position and speed sensor target on the rotor shaft.

The non-magnetic support element may include the second bearing surface.

The rotor shaft may additionally include a projection arranged proximate the second end. In such an embodiment, the rotor position and speed sensor target may be arranged on the projection.

The rotor position and speed sensor target may be configured as a radially magnetized magnet.

The rotor shaft may additionally include a shoulder arranged between the first bearing surface and the knurled section and configured to position or locate the first end plate on the rotor shaft along the first axis.

The rotor assembly additionally may include a rotor magnet disposed inside the rotor lamination and configured to generate an electromagnetic field. In such an embodiment, the first end-plate and the second end-plate may be together configured to retain the magnet inside the rotor lamination and maintain position of the rotor lamination on the rotor shaft.

Each of the first and second end plates may be configured from a non-magnetic material, e.g., brass, to short circuiting of the electromagnetic field generated by the rotor assembly.

At least one of the first and second end plates may provide a surface for removal of end plate material for balancing of the rotor assembly.

An electric starter assembly having a partial planetary gear set operatively connected to a starter pinion gear configured to slide along the first axis and the brushless electric motor, as disclosed above, is also provided.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a system schematic of a vehicle including a propulsion system with an internal combustion engine and a brushless electric starter therefor.

FIG. 2 is a cross-sectional view of the electric starter shown in FIG. 1, having a rotor shaft assembly arranged for rotation inside a stator assembly.

FIG. 3 is an exploded perspective back view of the electric starter shown in FIG. 2.

FIG. 4 is an exploded perspective front view of the electric starter shown in FIGS. 2 and 3.

FIG. 5 is an exploded partially cross-sectional side view of one embodiment of the rotor shaft assembly shown in FIGS. 2 and 3.

FIG. 6 is an exploded partially cross-sectional side view of another embodiment of the rotor shaft assembly shown in FIGS. 2 and 3.

### DETAILED DESCRIPTION

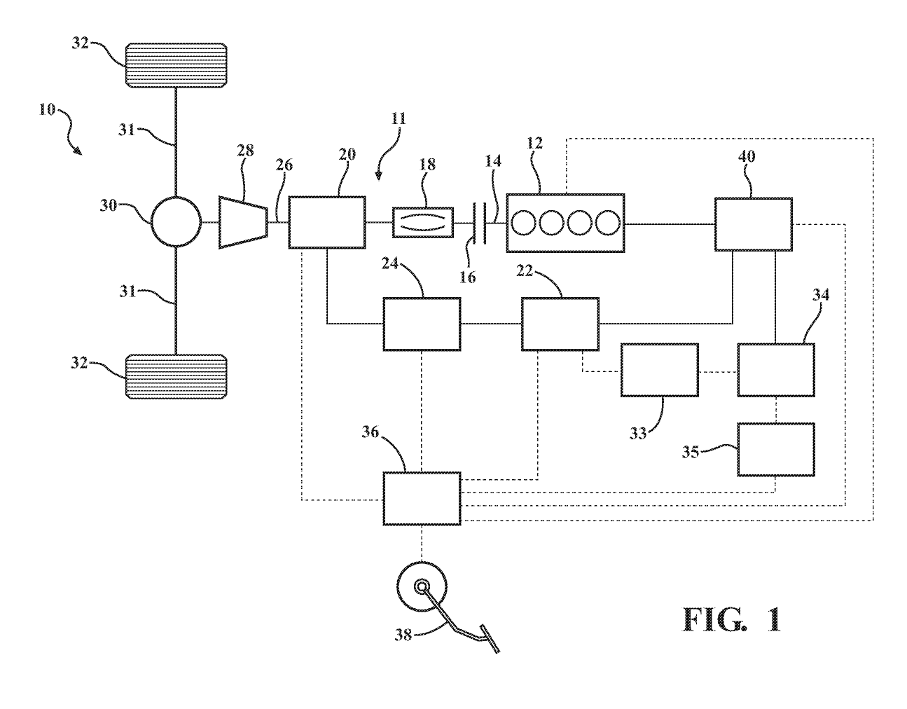

Referring to the drawings, wherein like reference numbers refer to like components, FIG. 1 shows a system schematic of a vehicle 10 having a driveline 11. The vehicle 10 may have a propulsion system employing solely an internal combustion engine 12. Alternatively, the vehicle 10 may be a hybrid electric vehicle (HEV) having a powertrain employing both the internal combustion engine 12 and an electric propulsion source. In the case of the HEV embodiment of the vehicle 10, either or both of the engine 12 and the electric propulsion source may be selectively activated to provide propulsion based on the vehicle operating conditions.

The internal combustion engine 12 outputs torque to a shaft 14. One or more decoupling mechanisms may be included along the shaft 14 to decouple output of the engine 12 from the remaining portions of the powertrain. A clutch 16 is provided to allow selection of a partial or complete torque decoupling of the engine 12. The clutch 16 may be a friction clutch having a plurality of friction plates at least partially engaged when the clutch is closed to transfer torque, and disengaged when the clutch is opened to isolate torque flow between the downstream portions of the powertrain and the engine 12. A torque converter 18 may also be included to provide a fluid coupling between the output portion of engine 12 and downstream portions of the vehicle driveline 11. The torque converter 18 operates to smoothly ramp up torque transfer from the engine 12 to the rest of the driveline 11. Also, the torque converter 18 allows a decoupling of the engine 12, such that the engine may continue to operate at low rotational speed without generating propulsion of the vehicle 10, e.g., at stationary idle conditions.

In the case of the HEV embodiment of the vehicle 10, the electric propulsion source may be a first electric machine 20 powered by a high-voltage external power source and energy storage system 22 including a high-voltage traction battery. Generally, a high-voltage traction battery is one that has an operating voltage greater than about 36 volts but less than 60 volts. For example, the traction battery may be a lithium ion high-voltage battery with a nominal voltage of 48 volts. In the HEV embodiment of the vehicle 10, high-voltage direct current is conditioned by an inverter 24 before delivery to the first electric machine 20. The inverter 24 includes a number of solid state switches and a control circuit operating to convert the direct current into three-phase alternating current to drive the first electric machine 20.

Additionally, in the case of the HEV powertrain, the first electric machine 20 may have multiple operating modes depending on the direction of power flow. In a motor mode, power delivered from the high-voltage traction battery allows the first electric machine 20 to generate output torque to a shaft 26. The output torque of the first electric machine 20 may then be transferred through a variable ratio transmission 28 to facilitate selection of a desired gear ratio prior to delivery of output torque to a final drive mechanism 30. The final drive mechanism 30 may be a multi-gear differential configured to distribute torque to one or more side- or half-shafts 31 coupled to wheels 32. The first electric machine 20 may be disposed either upstream of the transmission 28, downstream of the transmission 28, or integrated within a housing of the transmission 28.

The first electric machine 20 may also be configured to operate in a generation mode to convert rotational motion of various driveline 11 components into electrical power for storage in the traction battery 22. When the vehicle 10 is moving, whether propelled by the engine 12 or coasting from its own inertia, rotation of the shaft 26 turns an armature, or rotor, (not shown) of the first electric machine 20. Such rotational motion causes an electromagnetic field to generate alternating current that is passed through the inverter 24 for conversion into direct current. The direct current may then be provided to the high-voltage traction battery to replenish the charge stored at the battery. A unidirectional or bidirectional DC-DC converter 33 may be used to charge a low-voltage (e.g., 12 volt) battery 34 and supply the low voltage loads 35, such as 12 volt loads. When a bidirectional DC-DC converter 33 is used, it is possible to jump start the high-voltage traction battery 22 from the low-voltage battery 34.

The various propulsion system components discussed herein may have one or more associated controllers to control and monitor operation. An electronic controller 36, although schematically depicted as a single controller, may also be implemented as a system of cooperative controllers to collectively manage the propulsion system. Multiple controllers may be in communication via a serial bus (e.g., Controller Area Network (CAN)) or via discrete conductors. The controller 36 includes one or more digital computers, each having a microprocessor or central processing unit (CPU), read only memory (ROM), random access memory (RAM), electrically-programmable read only memory (EPROM), a high speed clock, analog-to-digital (A/D) and digital-to-analog (D/A) circuitry, input/output circuitry and devices (I/O), as well as appropriate signal conditioning and buffering circuitry. The controller 36 may also store a number of algorithms or computer executable instructions needed to issue commands to perform actions according to the present disclosure.

The controller 36 is programmed to monitor and coordinate operation of the various herein discussed propulsion system components. The controller 36 is in communication with the engine 12 and receives signals indicative of at least engine speed, temperature, as well as other engine operating conditions. The controller 36 may also be in communication with the first electric machine 20 and receive signals indicative of motor speed, torque, and the first electric machine's current draw. The controller 36 may also be in communication with the high-voltage traction battery 22 and receive signals indicative of such status indicators as a battery state of charge (SOC), temperature, and current draw. The controller 36 may also receive signals indicative of the circuit voltage across the high-voltage bus. The controller 36 may further be in communication with one or more sensors arranged at driver input pedal(s) 38 to receive signals indicative of specific pedal position, which may reflect acceleration demand by the driver. The driver input pedal(s) 38 may include an accelerator pedal and/or a brake pedal. In alternative embodiments such as a self-driving autonomous vehicle, acceleration demand may be determined sans driver interaction by a computer either on-board the vehicle 10 or external to the vehicle.

As mentioned above, in the case of the HEV embodiment of the vehicle 10, either one or both of the engine 12 and the first electric machine 20 may be operated at a particular time based at least on the propulsion requirements of the subject vehicle. During high torque demand conditions, the controller 36 may cause both, the engine 12 and the first electric machine 20 to be activated, such that each of the propulsion sources provides respective output torque for simultaneous or combined propulsion of the vehicle 10. In certain moderate torque demand conditions, generally the engine 10 operates efficiently and may be used as the sole propulsion source. For example, during highway driving of the HEV at a generally constant speed, the first electric machine 20 may be deactivated, such that only the engine 12 provides output torque.

Under other operating conditions of the HEV, the engine 12 may be deactivated, such that only the first electric machine 20 provides output torque. The clutch 16 may be opened to decouple the shaft 14 from the downstream portions of the powertrain. Specifically, during coast conditions where the HEV's driver allows the vehicle 10 to decelerate under driveline and road friction, as well as air resistance, the engine 12 may be deactivated and the first electric machine 20 operated in generator mode to recover energy. Additionally, even in a vehicle 10 using only the engine 12 for propulsion, deactivation of the engine 12 may be desirable during a temporary vehicle stop, such as at a traffic light. Instead of allowing the engine 12 to idle, fuel consumption may be reduced by deactivating the engine while the vehicle 10 is stationary. In both examples, it may be beneficial to rapidly restart the engine 12 in response to a subsequent resumption or increase of propulsion demand. A prompt startup of the engine 12 may avoid roughness and/or latency in power delivery being perceived by a driver of the vehicle 10.

The vehicle 10 also includes a second electric machine 40. The second electric machine 40 is coupled to the engine 12. The second electric machine 40 operates as an engine starter, and the entire assembly thereof is herein designated via the numeral 40. When the starter assembly is engaged with the engine 12 leading up to a combustion cycle, the starter turns a crankshaft of the engine to facilitate a cold start or a restart thereof. Specifically, the starter assembly 40 is configured to engage with and selectively apply an input torque to a, typically external, ring gear 12A that is attached to a crankshaft flywheel or flex-plate (not shown) of the engine 12, in order to start the engine. According to aspects of the present disclosure, the controller 36 is programmed to issue a command to start the engine 12 using the starter assembly 40 in response to an acceleration demand, such as detected via sensor(s) (not shown) at driver input pedal(s) 38, following a period of reduced acceleration demand.

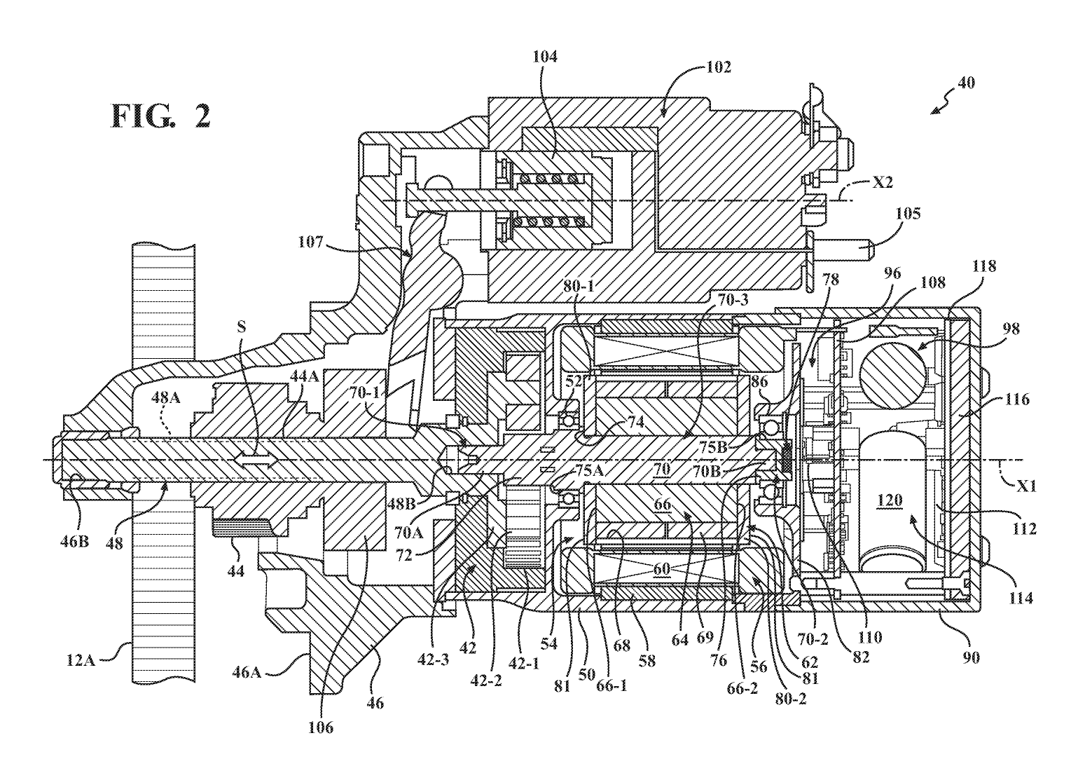

As shown in FIGS. 2-4, the starter assembly 40 is configured as an on-axis electric machine. As defined herein, “on-axis” denotes that the starter assembly 40 is designed and constructed such that the starter's gear-train components, electric motor, and electronic commutator assembly electronics, to be described in detail below, are all arranged on a common first axis X1. As disclosed, the starter assembly 40 may include a partial planetary gear set 42 operatively connected to a starter pinion gear 44, which is configured to slide along the first axis X1. The depicted partial planetary gear set 42 provides a required speed reduction, such as between 25:1 and 55:1, to output an appropriate amount of engine cranking torque. As additionally shown, the starter assembly 40 may include a gear-set casing 46 configured to house the partial planetary gear set 42 and having a mounting flange 46A for attachment to the engine 12 via appropriate fasteners.

As shown, the partial planetary gear set 42 includes an internal ring gear 42-1 fixed to the gear-set casing 46. The partial planetary gear set 42 further includes a plurality of pinion gears 42-2 in mesh with the internal ring gear 42-1, and a planet carrier 42-3 configured to hold the pinion gears. Specifically, the partial planetary gear set 42 may be directly connected to the starter pinion gear 44 via a shaft 48. To such an end, the shaft 48 may include an external spline 48A, while the pinion gear 44 includes a matching internal spline 44A, such that the pinion gear is enabled to slide along the pinion shaft when the pinion gear is pushed out for engagement with the ring gear 12A. As shown, the gear-set casing 46 is configured to support a nose of the shaft 48 via a bearing surface 46B.

The starter assembly 40 also includes a motor casing 50. The gear-set casing 46 may be fixed to the motor casing 50, such as via a suitable fastener (not shown). The motor casing 50 includes a first bearing 52 and is configured to house a brushless electric motor 54. The brushless electric motor 54 may, for example, be any of a number of motor types, such as an induction machine, a surface mount permanent magnet (PM) machine, an interior PM machine, a synchronous reluctance machine, a PM assist synchronous reluctance machine, a drag-cup induction machine, or a switched reluctance machine. The brushless electric motor 54 may also be a radial or an axial flux machine. The wire selection on the brushless electric motor 54 may, for example include a single wire conductor, which may have a round, square, or rectangular cross-section, which may be used for concentrated or distributed winding.

As compared with brushed electric motors, brushless motors generally benefit from increased duration of usable life due to the elimination of physical wear from contact of brushes at the commutator. Further, an electronically commutated electric machine may be capable of more precise control of motor speed as compared to a brushed motor. In some examples, the second electric machine may be operated using a field weakening control strategy to further improve control of the power output and extend motor speed. According to aspects of the present disclosure, the rotation of the starter assembly 40 output is synchronized with the rotation of the ring gear 12A to reduce noise, vibration, and harshness (NVH) which may occur during an engine 12 restart event.

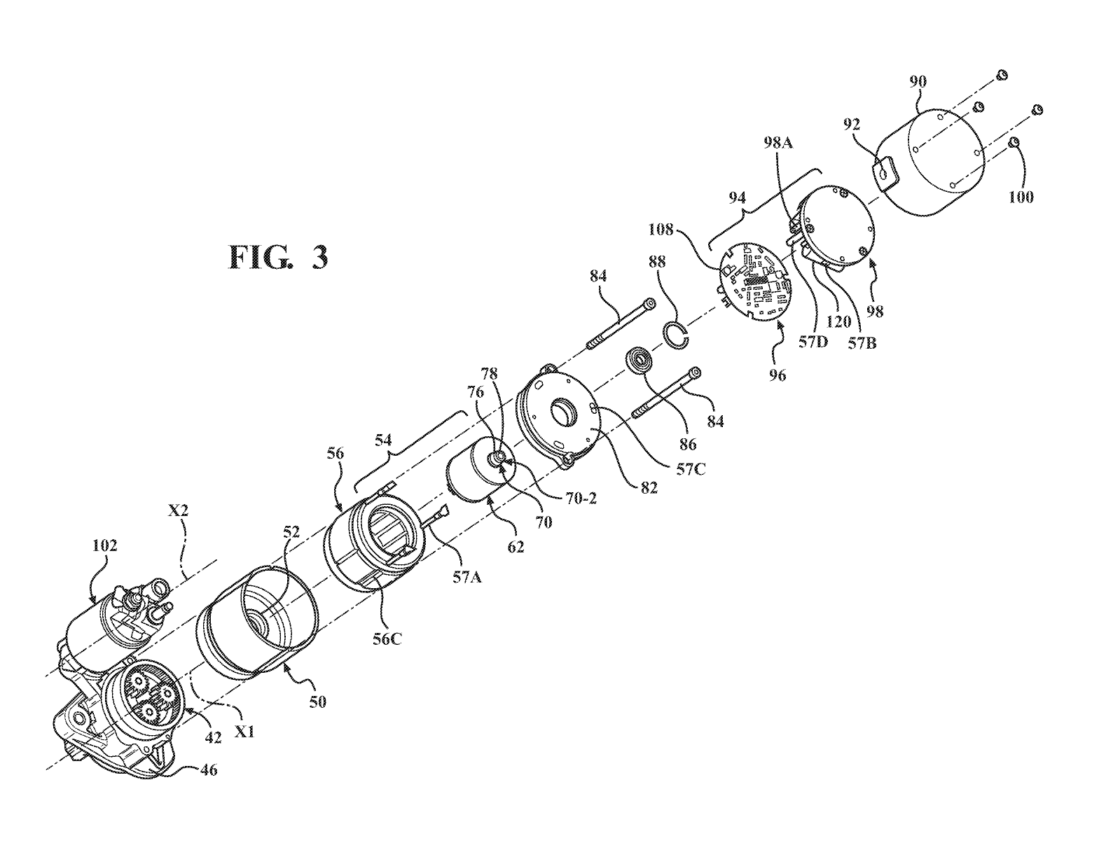

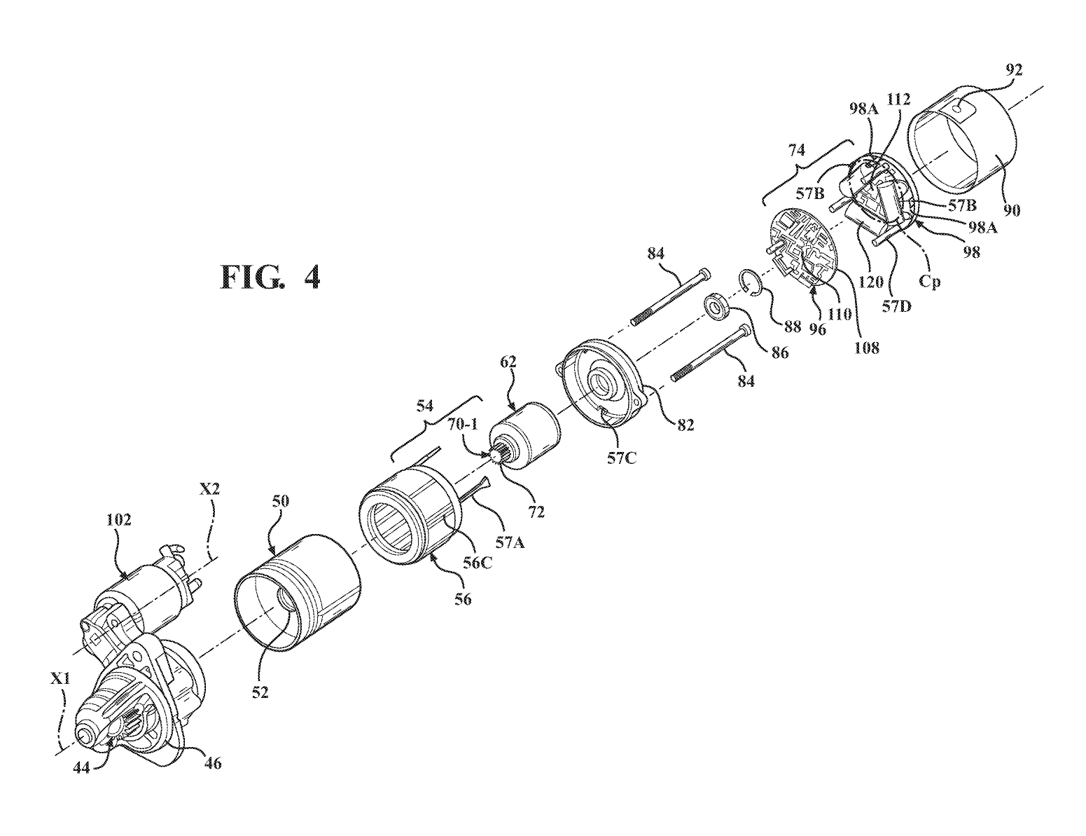

Referring to FIG. 2 depicting a cross-section of the starter assembly 40, and its exploded view in FIG. 3, the electric motor 54 includes a multi-phase stator assembly 56 having a stator core 58 arranged inside the motor casing 50 concentrically with respect to the first axis X1. As shown, the stator assembly 56 also includes three equally spaced electrical connectors 57A. A number of windings 60 is provided on the stator core 58 to generate a rotating magnetic field. The electric motor 54 also includes a rotor assembly 62 arranged for rotation inside the stator assembly 56. The rotor assembly 62 includes a rotor 64. The electric motor 54 is driven when the windings 60 are sequentially powered to create a rotating electromagnetic field, and the rotor assembly 62 is caused to rotate when the stator core 58 is thus energized. As shown in FIGS. 3-4, the stator assembly 56 may be fixed to the motor casing 50 via one or more keys 56C to orient the stator leads in a predetermined position with respect to the motor housing 50.

The stator core 58 is generally cylindrical in shape, and defines a hollow central portion to receive the rotor 64. According to at least one example, outer diameter of the stator core 58 may be limited to no greater than 80 millimeters. The rotor 64 is configured to rotate relative to the stator core 58 about the first axis X1. The rotor 64 may be formed in layers, or laminations 66, which are stacked in an axial direction along the first axis X1 where the lamination stack defines an active length of the starter assembly 40. According to one example, the lamination stack length is limited to be no greater than 40 millimeters. The overall size of the starter assembly 40 may be dependent on engine 12 packaging constraints, such that a ratio of the outer diameter of the stator core 58 to the lamination stack length is between about 1.5 and 3.5. The rotor laminations 66 having a first side 66-1 and an opposing second side 66-2.

The rotor laminations 66 may define a plurality of openings 68 disposed near the outer perimeter portion of the rotor, and each opening may be configured to hold a rotor magnet 69, i.e., such magnet(s) may be disposed inside the rotor laminations. The openings 68 are sized to enhance manufacturability, for example having an opening width of at least about 2 millimeters. Each rotor magnet 69 may be configured as a permanent magnet, for example, formed from a type of iron-based alloy, such as neodymium. The magnet(s) 69 may be configured to cooperatively generate a magnetic field which interacts with the assembly 56 when energized to cause movement of the rotor 64. For example, each of the permanent magnets 69 may be rectangular in shape to enhance simplicity and reduce manufacturing costs. However, other magnet shapes may be suitable for specific application of the brushless electric motor 54, according to the present disclosure.

The rotor laminations 66 with magnets 69 are arranged to create a number of magnetic poles around the rotor 64. Each of the magnets 69 is affixed within one of the openings 68 of the rotor laminations 66 and functions as a magnetic pole of the rotating electric machine. A magnetic flux is generated in a direction normal to rotor laminations 66, e.g., to the individual magnet body. The openings 68 in the laminations 66 may be shaped to include air gaps (not shown) on either side of each rotor lamination 66. Such air gaps between each pole may be sized to reduce flux leakage between the magnetic poles of the rotor 64. Each permanent magnet 69 is generally oriented within the rotor laminations 66 to have an opposing direction of polarity with respect to adjacent magnets in order to generate magnetic flux in opposite directions. The number of poles may be selected according to performance requirements of the electric motor 54.

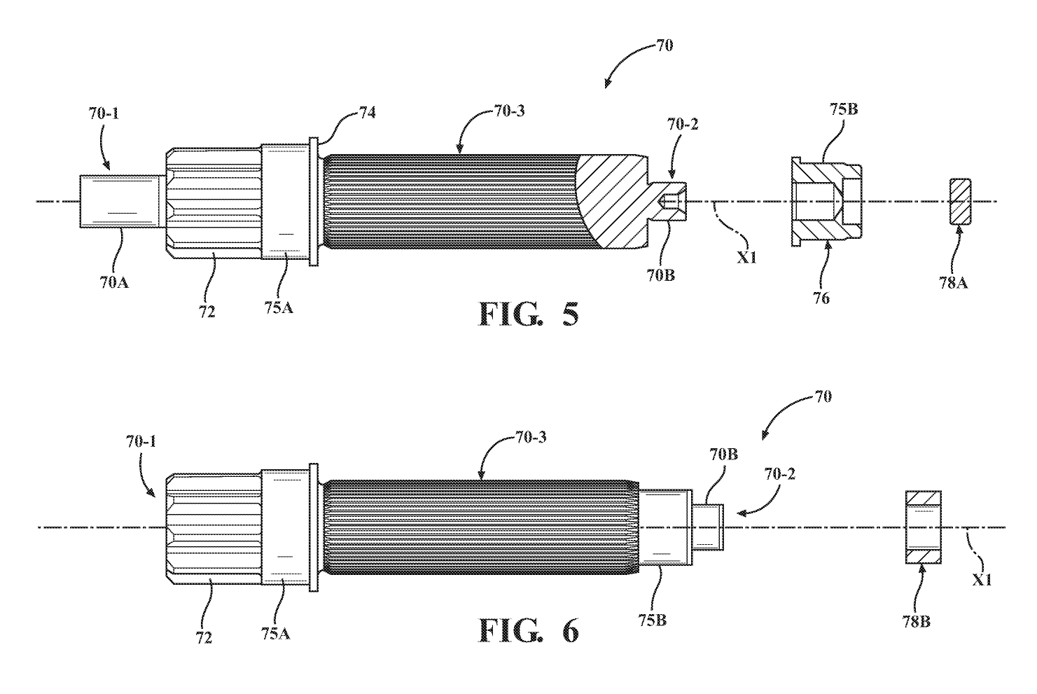

The rotor assembly 62 also includes a rotor shaft 70 having a first end 70-1 and a second end 70-2, and a knurled section 70-3 arranged between first and second ends 70-1, 70-2 (shown in detail in FIGS. 5 and 6). The rotor shaft 70 is arranged on the first axis X1, supported by the first bearing 52, and directly connected to a sun gear 72 configured to engage the partial planetary gear set 42. As shown, the sun gear 72 may be integrally formed with the rotor shaft 70. A nose or first projection 70A of the rotor shaft 70 may be piloted via a bearing surface 48B configured within the shaft 48, such that the shaft 48 and the shaft 70 each rotate about the first axis X1. The rotor shaft 70 also includes a first bearing surface 75A and a second bearing surface 75B. The first bearing surface 75A is supported by the first bearing 52.

As shown in FIGS. 2 and 5, the rotor shaft 70 may be configured as a sub-assembly that also includes a non-magnetic support element 76, for example affixed to the rotor shaft proximate the second end 70-2. The rotor assembly 62 also includes a rotor position and speed sensor target 78. As shown in FIG. 2, the rotor position sensor target 78 may be configured as one or more diametrically, i.e., on X1 axis, magnetized magnets 78A (shown in FIGS. 2 and 5) or radially, i.e., off X1 axis, magnetized magnets 78B (shown in FIG. 6) affixed to the rotor shaft 70. In the embodiment of FIGS. 2 and 5, the non-magnetic support element 76 is configured to support and retain the rotor position and speed sensor target 78 on the rotor shaft 70. Additionally, as shown in FIGS. 2 and 5, the non-magnetic support element may include or incorporate the second bearing surface 75B.

The rotor shaft 70 may additionally include a second projection 70B arranged proximate the second end 70-2, as shown in FIGS. 2, 5, and 6. In the embodiment of FIG. 6, the rotor position and speed sensor target 78 may be arranged on and fixed to, e.g., pressed on, the second projection 70B. The rotor shaft 70 may further include a shoulder 74 arranged between the first bearing surface 75A and the knurled section 70-3, (shown in FIGS. 2, 5, and 6). As shown in FIG. 2, the rotor laminations 66 are fixed to the rotor shaft 70 at and via the knurled section 70-3, such as using a press-on operation, for rotation therewith about the first axis X1. The rotor assembly 62 additionally includes a first end plate 80-1 arranged on the first side 66-1 of the rotor laminations 66 and a second end plate 80-2 arranged on the second side 66-2 of the rotor laminations.

As shown in FIG. 2, the shoulder 74 is configured to position the first end plate 80-1 on the shaft 70 along the first axis X1. In other words, the first end plate 80-1 may be pressed onto the rotor shaft 70 into fixed contact with the shoulder 74. When assembled onto the rotor shaft 70 on the respective sides of the rotor laminations 66, the first end-plate 80-1 and the second end-plate 80-2 together may be configured to retain the magnet(s) 69 inside the laminations, and maintain the position of laminations 66 on the rotor shaft 70. Each of the first and second end plates 80-1, 80-2 may be configured from a non-magnetic material, e.g., brass, to prevent shorting or diverting of the generated electromagnetic field generated via the magnet(s) 69. Additionally, at least one of the first and second end plates 80-1, 80-2 may provide a surface 81 which is configured, i.e., providing sufficient thickness, for removal of end plate material for balancing of the rotor assembly 62.

The electric motor 54 also includes a motor end-cap 82 configured to mate with and enclose the motor casing 50. As shown in in FIGS. 3 and 4, the motor end-cap 82 may be fastened to the gear-set casing 46 via a plurality of bolts 84, and thus retain the motor casing 50 therebetween. The motor end-cap 82 includes a second bearing 86 configured to support the shaft 70 for rotation with respect to the first axis X1. As shown in in FIGS. 3 and 4, a snap ring 88 may be employed to retain the second bearing 86 within the motor end-cap 82. As shown, the second bearing 86 may be configured to support the rotor shaft 70 at the second bearing surface 75B.

The electric motor 54 additionally includes an electronics cover 90 having a power connector aperture 92 (shown in FIGS. 3 and 4) for receiving electrical power from the high-voltage external power source and energy storage system 22. The electronics cover 90 is configured to mate with the motor end-cap 82 and house or enclose an electronic commutator assembly 94. The electronic commutator assembly 94 includes a control processor electronics assembly 96 and a power electronics assembly 98. The control processor electronics assembly 96 is arranged between the motor end-cap 82 and the power electronics assembly 98. In another arrangement (not shown), the power electronics assembly 98 may be arranged proximate to the motor end-cap 82. In such an embodiment, the control processor electronics assembly 96 may be arranged between the power electronics assembly 98 and electronics cover 90.

Accordingly, as shown in FIGS. 2-4, the electric motor 54 is arranged or sandwiched between the partial planetary gear set 42 and the electronic commutator assembly 94, while the partial planetary gear set 42 is arranged between the starter pinion gear 44 and the electric motor. The electronics cover 90 may be attached to the power electronics assembly 98 via appropriate fasteners, such as screws 100 shown in FIG. 3. As further shown in FIGS. 3 and 4, the power electronics assembly 98 includes an electrical terminal 98A configured to align with the power connector aperture 92 and receive electrical power from the high-voltage external power source and energy storage system 22 or low voltage-battery 34. To facilitate assembly of the electronic commutator assembly 94 with the electric motor 54, the motor end-cap 82 defines three apertures 57C configured to permit the three electrical connectors 57A to pass therethrough for engagement with the electrical terminals 57B (shown in FIG. 4). As shown, the power electronics assembly 98 may also include stand-offs or spacers 57D for establishing appropriate relative positioning of the electronic commutator assembly 94 with respect to the electric motor 54 along the first axis X1.

As shown in FIGS. 2-4, the starter assembly 40 additionally includes a solenoid assembly 102. The solenoid assembly 102 includes a pinion-shift solenoid 104 arranged on a second axis X2, which is arranged parallel to the first axis X1. The pinion-shift solenoid 104 is configured to be energized by electrical power from the high-voltage external power source and energy storage system 22 or low voltage battery 34, for example, received at a coil terminal 105. The solenoid assembly 102 is configured to be mounted and fixed to the gear-set casing 46, such as via a snap ring or other suitable fastener(s). The solenoid assembly 102 is further configured to shift or slide the starter pinion gear 44 along the first axis X1, as indicated by arrow S for meshed engagement with the ring gear 12A to restart the engine 12 upon a command from the controller 36. The pinion-shift solenoid 104 may shift the starter pinion gear 44, for example, via a one way-clutch 106, and a lever and bearing arrangement 107 (shown in FIG. 2).

The control processor electronics assembly 96 may include a processor circuit board 108 arranged substantially perpendicular to the first axis X1, and one or more rotor position and speed sensors 110 (shown in FIGS. 2 and 4), such as Hall-effect sensors, configured to cooperate with the rotor position and speed sensor target 78. The power electronics assembly 98 may include a power circuit board 112 arranged substantially parallel to the processor circuit board 108, an electrical current filter 114, and a heat sink 116 configured to absorb heat energy from the power circuit board 112. The power electronics assembly 98 may additionally include a thermally conductive electrical insulator 118 arranged between the power circuit board 112 and the heat sink 116. The electrical current filter 114 may include a plurality of filter capacitors 120 arranged on a pitch circle Cp (shown in FIG. 4) centered on and substantially perpendicular to the first axis X1. As shown in FIGS. 2-4, each of the plurality of filter capacitors 120 is arranged generally parallel to the power circuit board 112, between the power circuit board and the processor circuit board 108 along the first axis X1.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A brushless electric motor comprising:
a motor casing including a first bearing and a motor end-cap including a second bearing;
a multi-phase stator assembly arranged inside the motor casing concentrically with respect to a first axis; and
a rotor assembly arranged for rotation inside the stator assembly and including:
a rotor shaft arranged on the first axis and having a first end, a second end, a knurled section arranged between the first end and the second end, a first bearing surface arranged proximate the first end and supported by the first bearing, a second bearing surface arranged proximate the second end and supported by the second bearing, and a rotor position and speed sensor target;
a sun gear integrated with the rotor shaft proximate the first bearing surface and configured to engage a partial planetary gear set;
a rotor lamination having a first side and an opposing second side, wherein the rotor lamination is fixed to the rotor shaft at and by the knurled section for rotation therewith about the first axis; and
a first end plate arranged on the first side of the rotor lamination and a second end plate arranged on the second side of the rotor lamination.

2. The brushless electric motor of claim 1, wherein the rotor shaft additionally includes a non-magnetic support element proximate the second end.

3. The brushless electric motor of claim 2, wherein the non-magnetic support element is configured to support and retain the rotor position and speed sensor target on the rotor shaft.

4. The brushless electric motor of claim 3, wherein the non-magnetic support element includes the second bearing surface.

5. The brushless electric motor of claim 1, wherein the rotor shaft additionally includes a projection arranged proximate the second end, and wherein the rotor position and speed sensor target is arranged on the projection.

6. The brushless electric motor of claim 1, wherein the rotor position and speed sensor target is configured as a radially magnetized magnet.

7. The brushless electric motor of claim 1, wherein the rotor shaft additionally includes a shoulder arranged between the first bearing surface and the knurled section and configured to position the first end plate on the rotor shaft along the first axis.

8. The brushless electric motor of claim 1, wherein the rotor assembly additionally includes a rotor magnet disposed inside the rotor lamination and configured to generate an electromagnetic field, and wherein the first end-plate and the second end-plate are together configured to retain the magnet inside the rotor lamination.

9. The brushless electric motor of claim 8, wherein each of the first and second end plates is configured from a non-magnetic material to prevent short circuiting of the generated electromagnetic field.

10. The brushless electric motor of claim 1, wherein at least one of the first and second end plates provides a surface for removal of end plate material for balancing of the rotor assembly.

11. An electric starter assembly comprising:
a partial planetary gear set operatively connected to a starter pinion gear configured to slide along the first axis;
a motor casing including a first bearing and a motor end-cap including a second bearing;
a multi-phase stator assembly arranged inside the motor casing concentrically with respect to a first axis; and
a rotor assembly arranged for rotation inside the stator assembly and including:
a rotor shaft arranged on the first axis and having a first end, a second end, a knurled section arranged between the first end and the second end, a first bearing surface arranged proximate the first end and supported by the first bearing, a second bearing surface arranged proximate the second end and supported by the second bearing, and a rotor position and speed sensor target;
a sun gear integrated with the rotor shaft proximate the first bearing surface and configured to engage the partial planetary gear set;
a rotor lamination having a first side and an opposing second side, wherein the rotor lamination is fixed to the rotor shaft at and by the knurled section for rotation therewith about the first axis; and
a first end plate arranged on the first side of the rotor lamination and a second end plate arranged on the second side of the rotor lamination.

12. The electric starter assembly of claim 11, wherein the rotor shaft additionally includes a non-magnetic support element proximate the second end.

13. The electric starter assembly of claim 12, wherein the non-magnetic support element is configured to support and retain the rotor position and speed sensor target on the rotor shaft.

14. The electric starter assembly of claim 13, wherein the non-magnetic support element includes the second bearing surface.

15. The electric starter assembly of claim 11, wherein the rotor shaft additionally includes a projection arranged proximate the second end, and wherein the rotor position and speed sensor target is arranged on the projection.

16. The electric starter assembly of claim 11, wherein the rotor position and speed sensor target is configured as a radially magnetized magnet.

17. The electric starter assembly of claim 11, wherein the rotor shaft additionally includes a shoulder arranged between the first bearing surface and the knurled section and configured to position the first end plate on the rotor shaft along the first axis.

18. The electric starter assembly of claim 11, wherein the rotor assembly additionally includes a rotor magnet disposed inside the rotor lamination and configured to generate an electromagnetic field, and wherein the first end-plate and the second end-plate are together configured to retain the magnet inside the rotor lamination.

19. The electric starter assembly of claim 18, wherein each of the first and second end plates is configured from a non-magnetic material to prevent short circuiting of the generated electromagnetic field.

20. The electric starter assembly of claim 11, wherein at least one of the first and second end plates provides a surface for removal of end plate material for balancing of the rotor assembly.
